(19) United States
(12) Patent Application Publication
(10) Pub. No.: US 2008/0180823 A1
(43) Pub. Date: Jul. 31, 2008

(54) COLOR WHEEL

(75) Inventors: CHIH-WEI TSO, Tu-Cheng (TW); CHIN-MING CHUNG, Tu-Cheng (TW); PI-TSUNG HSU, Tu-Cheng (TW); HSIN-LI LIN, Tu-Cheng (TW)

Correspondence Address: PCE INDUSTRY, INC.;ATT. CHENG-JU CHIANG, 458 E. LAMBERT ROAD, FULLERTON, CA, 92835, US

(73) Assignee: HON HAI PRECISION INDUSTRY CO., LTD., Tu-Cheng (TW)

(21) Appl. No.: 11/926,487

(22) Filed: Oct. 29, 2007

(30) Foreign Application Priority Data
Jan. 30, 2007 (CN) 200710200130.X

(51) Int. Cl. G02B 7/00

(52) U.S. Cl. 359/892; 359/891; 156/228; 425/411

(57) ABSTRACT

A color wheel includes a motor, a filter and a dark slide. The motor has an adhering section and the filter is affixed to the motor by the adhering section. The filter has a first surface facing the motor and a second surface opposite to the first surface. The dark slide is affixed to the filter on the second surface. The dark slide matches the location and shape of the adhering section to block light from projecting onto the adhering section. The thermal expansion coefficients of the dark slide and the filter are substantially identical to avoid damage from thermal stress caused by heating and cooling. An assembling tool and an assembling method are also provided in the embodiments.

### TECHNICAL FIELD

The present invention relates to color wheels, and, more particularly, to a color wheel configured for use in a projector.

### BACKGROUND

Projectors are display devices commonly used for entertainment, academic presentations, and business demonstrations. Projectors include cathode ray tube (CRT) projectors, liquid crystal display (LCD) projectors, digital light processing (DLP) projectors and liquid crystal on silicon (LCOS) projectors. Among these projectors, DLP projectors possess the advantages of high brightness, vivid color, low response time, smallness and lightness size and construction.

A DLP projector includes a digital micro-mirror device (DMD) chip configure for reflecting light and forming images on a screen through a light projection system. In a DLP projector with a single DMD chip, colors are produced by placing a spinning color wheel between the lamp and the DMD chip. The DMD chip is synchronized with the rotating motion of the color wheel so that the red, green, and blue images are displayed sequentially at a sufficiently high rate that the observer sees a composite full color image.

A typical color wheel includes a motor and a filter. The filter is affixed to an adhering section of the motor by adhesives. However, during the operations of the color wheel, light from a lamp of the projector can be projected through the filter and arrive on the adhering section, thus degrading adherence of the filter to the motor. As a result, the filter is prone to become loose or even fall off the adhering section. Therefore, it is desired to develop a color wheel with greater adherence.

### SUMMARY

In accordance with a preferred embodiment, a color wheel includes a motor, a filter and a dark slide. The motor has an adhering section and the filter is affixed to the motor by the adhering section. The filter has a first surface facing the motor and a second surface on an opposite side of the filter to the first surface. The dark slide is affixed to the filter on the second surface. The dark slide matches the location and shape of the adhering section and is positioned so as to block light beams from being projected onto the adhering section. The thermal expansion coefficients of the dark slide and the filter are substantially identical, thus avoiding damage due to thermal stress caused by heating and cooling. An assembling tool and an assembling method are also provided.

Other advantages and novel features will be drawn from the following detailed description of preferred embodiments when conjunction with the attached drawings.

### BRIEF DESCRIPTION OF THE DRAWINGS

Many aspects of the present color wheel can be better understood with reference to the following drawings. The components in the drawings are not necessarily drawn to scale, the emphasis instead being placed upon clearly illustrating the principles of the present color wheel module. Moreover, in the drawings, like reference numerals designate corresponding parts throughout the several views.

FIG. 1 is an isometric, exploded view of a color wheel, according to a first preferred embodiment;

FIG. 2 is an isometric, assembled view of the color wheel of FIG. 1;

FIG. 3 is a cross-sectional view of the color wheel according to the first preferred embodiment, before being assembled;

FIG. 4 is a cross-sectional view of the color wheel according to the first preferred embodiment, after being assembled;

FIG. 5 is an isometric, exploded view of the color wheel, according to a second preferred embodiment;

FIG. 6 is a cross-sectional view of the color wheel according to the second preferred embodiment, before being assembled; and

FIG. 7 is a cross-sectional view of the color wheel according to the second preferred embodiment, after being assembled.

### DETAILED DESCRIPTION OF THE PREFERRED EMBODIMENT

Embodiments of the present color wheel will now be described in detail below and with reference to the drawings.

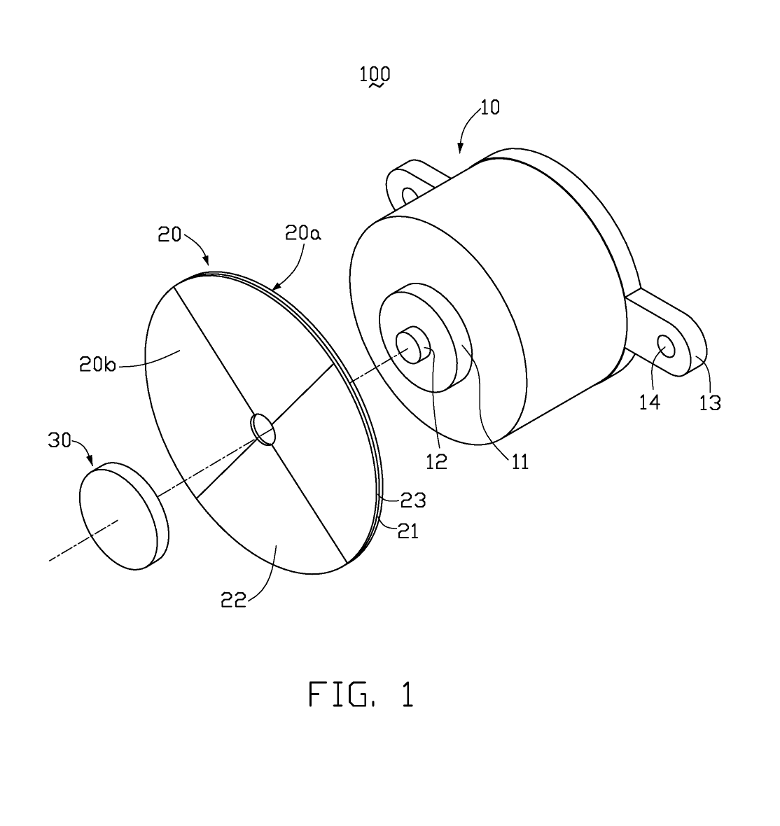

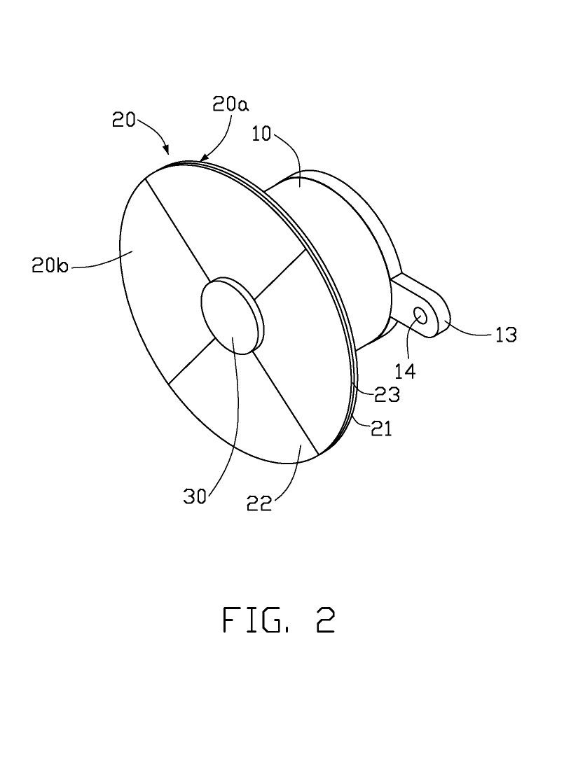

Referring to FIG. 1 and FIG. 2, a color wheel 100, in accordance with a first preferred embodiment, includes a motor 10, a filter 20 and a dark slide 30. The motor 10 includes an adhering section 11. The filter 20 is affixed to the adhering section 11 by adhesives. The filter 20 has a first surface 20a facing the motor 10 and a second surface 20b opposite to the first surface 20a. The dark slide 30 is affixed to the filter 20 on the second surface 20b by adhesive. The dark slide 30 matches the location and size of the adhering section 11 to block light from projecting to the adhering section 11. The thermal expansion coefficients of the dark slide 30 and the filter 20 are substantially identical.

The motor 10 includes a rotator 12 and a stator (not shown in the figures). The adhering section 11 is securely disposed on the rotator 12. When the motor 10 operates, the rotator 12 is driven to rotate by electromagnetism, whilst simultaneously the adhering section 11 drives the filter 20 to rotate with the rotator 12. In this embodiment, the rotator 12 can be a rotating shaft and the adhering section 11 is a disk securely disposed on the rotating shaft. The filter 20 is affixed to the adhering section 11 disposed and located opposite to the motor 10. The motor 10 includes two wings 13 in the bottom. A hole 14 is defined in each wing 13 for fixing the color wheel 100 to a predetermined place (not shown in the drawings).

The filter 20 includes a circular transparent disk 21 defining a number of sectors 22. Each sector 22 is covered with a different coating film 23. In this embodiment, the circular transparent disk 21 is made of glass and defines four sectors which are respectively configured for applying red, green, blue and white films 23 onto the surface of the circular transparent disk 21. Alternatively, the circular transparent disk 21 can be made of any other suitable transparent material. Furthermore, the number of the sectors on the surface of the circular transparent disk 21 can be changed on different schemes of the filter 20.

The filter 20 is fixed to the adhering section 11 directly to thus allow at least one loading member used in a typical color wheel to be omitted. It also helps to reduce the assembling processes of the filter 20 and, therefore, reduce the cost of the color wheel 100.

The dark slide 30 has to meet following requirements: (1) blocking light from projecting to the adhering section 11 to prevent degradation of the adhering strength of the adhering section; (2) having a thermal expansion coefficient substantially identical to that of the filter 20 to avoid the damage of thermal stress to the filter 20. Accordingly, the dark slide 30 used in this embodiment is a reflective slide made of the same material of the filter 20. Alternatively, the dark slide 30 used in this embodiment can be made of other materials which meets the requirements of the dark slide 30.

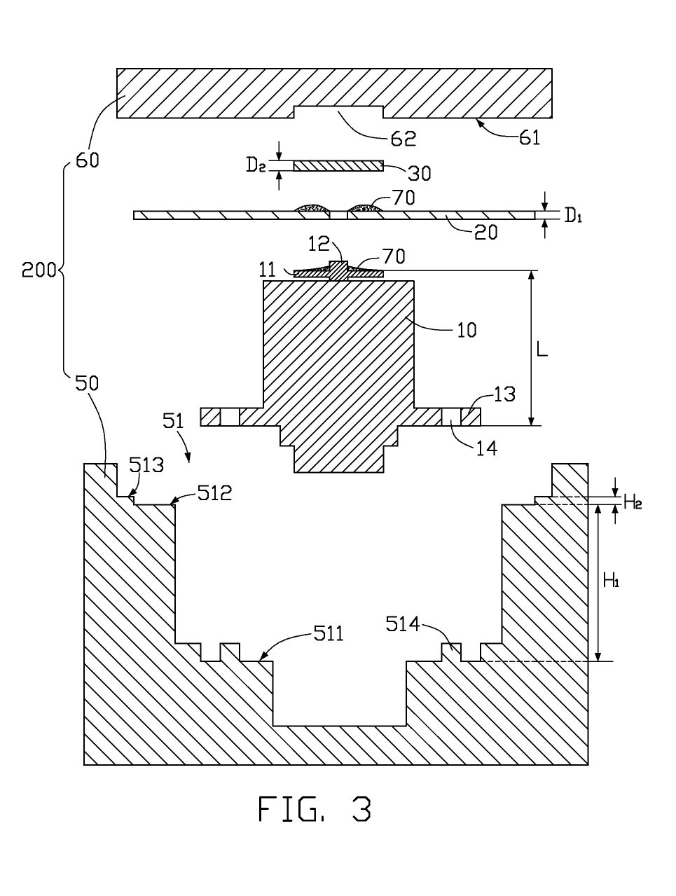

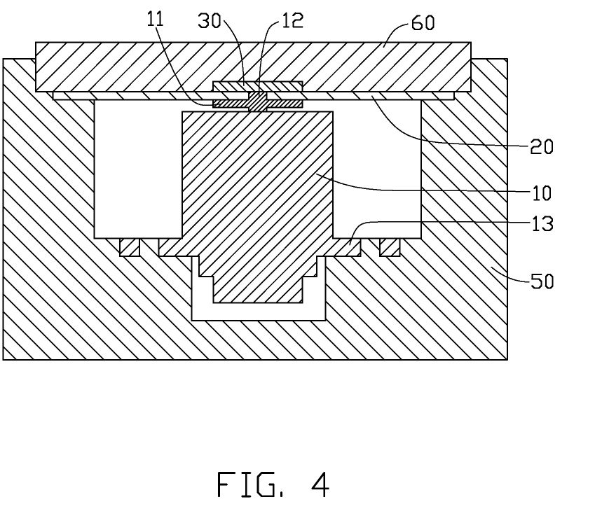

Referring to FIG. 3 and FIG. 4, an assembling tool 200 is provided for assembling the color wheel 100. The assembling tool 200 includes a base 50 and a press 60. The base 50 includes a positioning cavity 51 which provides a motor pit 511, a filter pit 512 and a press pit 513. The motor pit 511, the filter pit 512 and the press pit 513 are respectively configured for positioning the motor 10, the filter 20 and the press 60. The press 60 includes a pressing plane 61 corresponding to the positioning cavity 51 and a slide pit 62 defined in the pressing plane 61. The pressing plane 61 is configured for pushing the filter 20 toward the adhering section 11, the slide pit 62 is configured for positioning the dark slide 30.

The assembling of the color wheel 100 includes the following steps:

(a) positioning the motor 10 to the motor pit 511;
(b) applying a curable adhesive 70 to the adhering section 11;
(c) positioning the filter 20 to the filter fit 512;
(d) applying the adhesive 70 to the second surface 20b of the filter 20 opposite to the adhering section 11;
(e) placing the dark slide 30 on the filter 20 where the adhesive 70 is applied;
(f) moving the press 60 forward the press pit 513 for combining the filter 20 and the dark slide 30 together;
(g) curing the adhesive 70 to complete the assembly of the color wheel 100.

The base 50 and the press 60 are made of steels which are durable to high temperature and resistant to deformations. The base 50 is pillar-like, with either a round or square configuration. In this embodiment, the base 50 is a round pillar and the positioning cavity 51 is defined in the center of the round pillar. The positioning cavity 51 forms three steps from the bottom to the top. Each step corresponds to a pit for positioning. The bottom step defines the motor pit 511, the middle step defines the filter pit 512 and the top step defines the press pit 513. Two fixing shafts 514 are provided in the bottom step for matching with the holes 14 defined on the wings 13 to fix the motor 10. Depth H1 describing the distance between the bottom step to the middle step is substantially equal to the distance L between the bottom surface of the wing 13 and the top surface of the adhering section 11. When the filter 20 is positioned on the filter pit 512, the filter 20 is also positioned on the adhering section 11. H2 is the distance between the middle step and the top step and is substantially equal to the thickness D1 of the filter 20 so that when the press 60 is combined with the press pit 513, the pressing plane 61 presses the filter 20. The slide pit 62 is defined correspondingly to the adhering section 11. The depth of the slide pit 62 is substantially equal to the thickness D2 of the dark slide 30 to make the slide pit 62 to position and press the dark slide 30.

The curable adhesive 70 may be an ultraviolet curable adhesive which is curable under ultraviolet light. In addition, depending on different production requirements, other type of curable adhesives are also acceptable.

Comparing with the typical color wheel, the color wheel in this embodiment employs a dark slide to block light from projecting directly onto the adhering section of the filter to avoid degradation of adhering strength of the adhering section. The thermal expansion coefficient of the dark slide is substantially identical to that of the filter to eliminate damage of thermal stress between the dark slide and the filter after the heating and cooling cycles during operations.

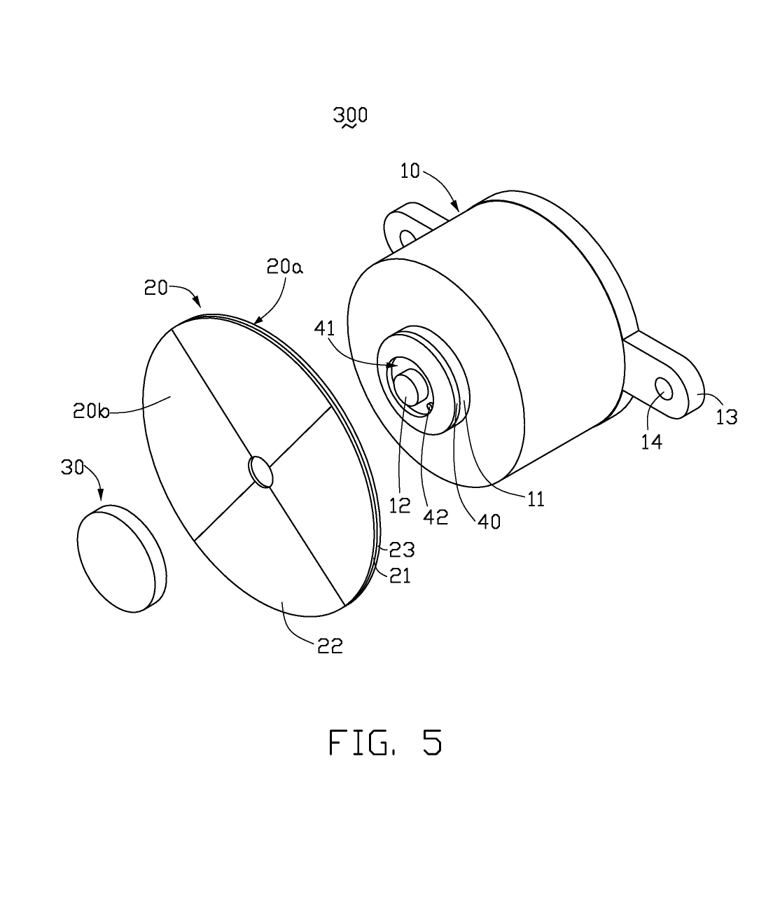

Referring to FIG. 5, an isometric, exploded view of a color wheel 300 in a second embodiment is shown. Typically, the adhering section 11 and the rotator 12 are monolithically formed by a same material, for example, steel. The filter is normally made of other materials which are different from the adhering section 11 and the rotator 12. In this embodiment, the adhering section 11 and the rotator 12 are of single-piece construction and formed from steel and the filter 20 is made of glass. The thermal expansion coefficients of the steel and the glass are different. The filter 20 is heated to be affixed to adhering section 11. Furthermore, during the operation of the color wheel 300, the filter 20 and the adhering section 11 suffer from heating and cooling cycles, thermal stress is thus created due to the difference in thermal expansion coefficients. The color wheel 300 in this embodiment further includes a thermal stress absorber 40 disposed between the filter 20 and adhering section 11 configured for absorbing the thermal stress suffered by the filter 20. The thermal stress absorber 40 is fixed on the adhering section 11 with adhesive.

The thermal expansion coefficient of the glass used in the filter 20 in this embodiment is less than that of the steel used in the adhering section 11 within the working temperatures of the color wheel 300. The thermal expansion coefficient of the thermal stress absorber 40 is greater than or equal to that of the filter 20 and less than or equal to that of the adhering section 11. Practically, in this embodiment, the thermal expansion coefficient of the glass used in the filter 20 is between 3.0×10⁻⁶/° C. and 1.0×10⁻⁵/° C. within the working temperatures of the color wheel 300. The thermal expansion coefficient of the thermal stress absorber 40 is greater than 8.1×10⁻⁶/° C. within the working temperatures of the color wheel 300.

The thermal stress absorber 40 arranged in this embodiment can be replaced by other materials which can absorb the thermal stress suffered by the filter 20. Practically, it is pretty difficult to make the rotation of the color wheel 300 symmetrically match to the rotating shaft of the motor 10. As a result, it causes an eccentric force and results in noise and energy-wastage. The thermal stress absorber 40 in this embodiment may further define a circular groove 41. The circular tank 41 receives a balancer 42 for balancing the color wheel 300 to remove eccentricities during the rotation of the color wheel 300.

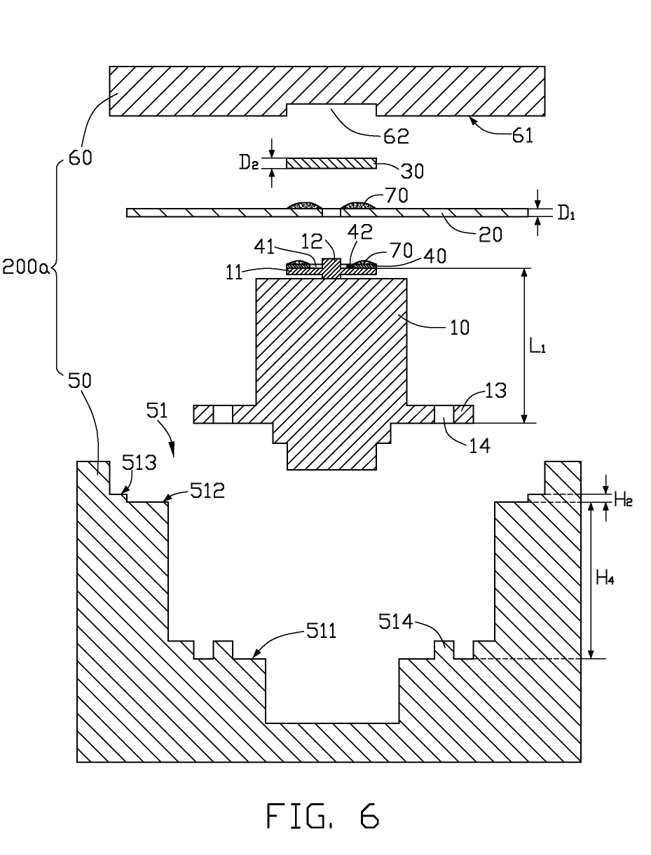

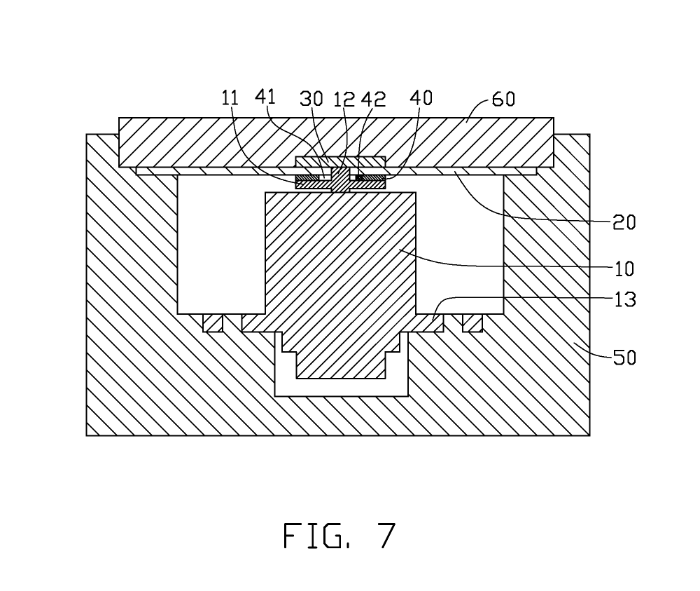

Referring to FIG. 6 and FIG. 7, an assembling tool 200a is provided for assembling the color wheel 300. The assembling tool 200a is similar to the assembling tool 200, but the difference is that the assembling tool 200a defines a length H4 which describes the distance from the bottom step to the middle step and is equal to the length L1 of the distance from the bottom surface of the wing 13 to the top surface of the thermal stress absorber 40. Accordingly, when the filter 20 is positioned in the filter pit 512, the thermal stress absorber 40 is attached to the filer 20.

It will be understood that the above particular embodiments and methods are shown and described by way of illustration only. The principles and features of the present invention may be employed in various and numerous embodiments thereof without departing from the scope of the invention as claimed. The above-described embodiments illustrate the scope of the invention but do not restrict the scope of the invention.

What is claimed is:

1. A color wheel comprising:
a motor having an adhering section;
a filter affixed to the motor by the adhering section;
a dark slide disposed on the filter opposite to the motor, the dark slide blocking light to be projected through the filter, from projecting onto the adhering section.

2. The color wheel as claimed in claim 1, wherein the motor comprises a rotator with an axis, the adhering section is securely attached on the rotator such that the filter and the adhering section are rotatable with the rotator about the axis, the dark slide and the adhering section are disposed at opposite sides of the filter and aligned with each other along the axis.

3. The color wheel as claimed in claim 2, wherein the shape of the dark slide matches that of the adhering section and the size of the dark slide is equal to or greater than that of the adhering section to allow the dark slide blocking the light from projecting onto the adhering section.

4. The color wheel as claimed in claim 1, wherein a thermal expansion coefficient of the dark slide is substantially identical to that of the filter.

5. The color wheel as claimed in claim 1, wherein the dark slide is a reflective slide which reflects lights projected onto the dark slide.

6. The color wheel as claimed in claim 1, wherein the dark slide and the filter are made of the same material.

7. The color wheel as claimed in claim 1, wherein the filter has a first surface facing the motor and a second surface opposite to the first surface, the dark slide is affixed to the filter on the second surface by adhesive.

8. The color wheel as claimed in claim 1, wherein a thermal expansion coefficient of the adhering section is different to that of the filter.

9. The color wheel as claimed in claim 8, further comprising a thermal stress absorber disposed between the adhering section and the filter.

10. The color wheel as claimed in claim 9, wherein a thermal expansion coefficient of the thermal stress absorber is greater than that of the filter and less than that of the adhering section.

11. The color wheel as claimed in claim 10, wherein the thermal expansion coefficient of the thermal stress absorber is between 3.0×10⁻⁶/° C. and 1.0×10⁻⁵/° C.

12. The color wheel as claimed in claim 9, wherein the thermal stress absorber and the filter are made of the same material.

13. The color wheel as claimed in claim 9, wherein the thermal stress absorber defines a circular groove receiving a balancer therein for balancing the color wheel.

14. An assembling tool configured for assembling the color wheel as claimed in claim 1, comprising:
a press comprising a pressing plane and a slide pit configured for pushing the filter toward the adhering section and positioning the dark slide respectively; and
a base comprising a positioning cavity, the positioning cavity providing a motor pit, a filter pit and a press pit configures for positioning the motor, the filter and the press.

15. An assembling method for assembling a color wheel by the assembling tool as claimed in claim 14, the color wheel comprising a motor with an adhering section, a filter with a first surface and an opposite second surface, and a dark slide, the method comprising:
positioning the motor in the motor pit;
applying a curable adhesive to the adhering section;
positioning the filter in the filter pit with the first surface facing the curable adhesive;
applying another curable adhesive onto the second surface of the filter;
placing the dark slide on the filter where the adhesive is applied;
moving the press toward the press pit for combining the filter and the dark slide together; and
curing the adhesives to secure the dark slide and the filter to the motor.

16. The assembling method as claimed in claim 15, further comprising:
placing a thermal stress absorber on the adhering section before applying the curable adhesive to the adhering section.
